(19) United States
(12) Patent Application Publication
(10) Pub. No.: US 2014/0302201 A1
(43) Pub. Date: Oct. 9, 2014

(54) Wine Additives for Improving the Taste, Aroma and Quality of Wine

(71) Applicant: Robert Scotland Clark, III, Fallbrook, CA (US)

(72) Inventor: Robert Scotland Clark, III, Fallbrook, CA (US)

(21) Appl. No.: 13/857,227

(22) Filed: Apr. 5, 2013

(51) Int. Cl. C12H 1/10

(52) U.S. Cl. CPC C12H 1/10
USPC 426/87; 426/573; 426/576; 426/592; 426/330.4

(57) ABSTRACT

The present invention provides compositions and methods of using these compositions to improve the taste, aroma and quality of wine. The compositions are aqueous solutions containing gelatin having a concentration of about 45 g/L to about 55 g/L, gum Arabic having a concentration of about 92 g/L to about 112 g/L and copper sulfate having a concentration of about 0.014 g/L to about 0.018 g/L or ascorbic acid having a concentration of about 223 g/L to about 273 g/L and gum Arabic having a concentration of about 46 g/L to about 56 g/L or gelatin having a concentration of 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L. When added to a glass of wine, or in larger volumes to a bottle or cask of wine, it improves the taste by reducing the bitterness and acidity. The invention also provides kits containing these compositions for adding to wine before consumption.

### CROSS-REFERENCE TO RELATED APPLICATIONS

None

### STATEMENT REGARDING FEDERALLY SPONSORED RESEARCH OR DEVELOPMENT

None

### INCORPORATION-BY-REFERENCE OF MATERIAL SUBMITTED ON COMPACT DISC

None

### BACKGROUND OF THE INVENTION

(1) Field of the Invention

The present invention relates to compositions and methods of using those compositions to enhance, improve, and/or recover the taste, aroma, and quality of wine.

(2) Description of Related Art

The wine making process is complicated and varies with the type of wine being produced. Each step adds a specific character to the wine and depending on the desired taste, agents may be added to control the result of a particular step. The process begins with selecting, harvesting and preparing the grapes for primary fermentation. At this stage, the must or pulp of the grapes is fermented with the grape skins to a greater or lesser degree depending on the desired color of the wine.

Primary fermentation may occur naturally from the yeast present on the exterior of the grapes. However, this often gives unpredictable results. Two of the problems with the use of wild ferments are incomplete fermentation and the production of unpleasant acetic acid as a by-product. Consequently, cultured yeast is often added to the must.

During the primary fermentation, the yeast cells feed on the sugars in the pulp and multiply, producing carbon dioxide gas and alcohol. For every gram of sugar that is converted, about half a gram of alcohol is produced. Therefore, to achieve a 12% alcohol concentration, the must should contain about 24% sugars. The temperature applied during fermentation varies with the type of wine being produced and affects the speed of this reaction and consequently the taste of the wine. Primary fermentation often takes between one and two weeks.

After fermentation, the wine, also referred to as free run wine is pumped into tanks and the skins are pressed to extract the remaining wine. In some cases, the pressing precedes fermentation and the wine obtained from this operation is often referred to as press wine. The press wine often contains a higher concentration of tannins and may be blended with the free run wine to achieve the desired taste. The additional tannins encourage protein precipitation later in the process. It also provides potassium ions that precipitate tartaric acid also referred to as cream of tarter resulting in increased pH that may be desirable for overly acidic grapes.

In these tanks the wine undergoes a bacterial fermentation. Specially cultivated strains of lactic acid bacteria are introduced to the wine that convert malic acid into lactic acid. This process decreases the acid and softens the taste of the wine. If the pH rises above the desired range the acidity can be increased by the addition of tartaric acid. Often times these tanks are constructed of oak, which imparts oak aromas and tannins to the wine. The wine is aged in these tanks over a period of weeks up to several months. During this time the wine is kept under an airlock or topped with similar wine to protect it from oxidation. In addition, the remaining yeast cells and other fine particles and proteins from the grapes are allowed to settle which clarifies the wine.

For some types of wine a “heat stabilization” step is included in the process to remove unstable proteins by absorption onto bentonite, preventing them from precipitating in bottled wine.

After the fermentation steps the wine is cold stabilized remove excess tartrates that can form sediment in bottled wine. During the cold stabilizing, the temperature of the wine is dropped to just above freezing for one to two weeks. This causes the formation of tartrate crystals also known as “wine crystals” or “wine diamonds” on the sides of the tank. When the wine is drained from the tank, the tartrates are left behind.

Tests are run periodically to check the status of the wine. Common tests include Brix, pH, total acidity, malic acid, volatile acidity, residual sugar, sulfur content, crystallization of potassium hydrogen tartrate, percent alcohol as well as sensory tests such as taste and smell. These tests may be performed throughout the making of the wine as well as prior to bottling and provide the data to assist in determining whether remedial action may be required to achieve the desired taste.

Brix is one measure of the soluble solids in the wine. These solids include sugar, salts, acids and tannins, sometimes referred to as Total Soluble Solids (TSS). Because sugar is the dominant compound in grape juice, these units are effectively a measure of sugar level. The level of sugar in the grapes determines the final alcohol content of the wine as well as an indirect index of grape maturity. Brix (“Bx”) is measured in grams per hundred grams of solution, so 20 Bx means that 100 grams of juice contains 20 gm of dissolved compounds.

Volatile acidity test verifies the presence of steam distillable acids such as acetic (the dominant acid present), lactic, butyric, propionic and formic acid. A variety of equipment may be used to determine the presence of these acids including a cash still, HPLC and gas chromatography. The amount of volatile acidity found in sound grapes is negligible, because it is a by-product of microbial metabolism.

Sulfur content is used to measure the amount of sulfur dioxide present in the wine. Sulfur dioxide is often added to wine to reduce the amount of dissolved oxygen that the acetic acid bacteria require for survival. It is normally added to wine as liquid sulfur dioxide or as sodium or potassium metabisulfite.

Other agents may be used to affect the taste and appearance of the wine. Fining agents for example, are often used to remove tannins, reduce astringency and remove microscopic particles that can cloud wine. One fining agent, gelatin, has been used for centuries for clarifying wine and is most commonly used to reduce tannin content. Gelatin forms sediment with undesirable particles and chemicals in the wine and is removed by filtration prior to bottling. Other fining agents include: Bentonite, Kieselsol, micronized potassium caseinate, egg albumin, isinglass, polyvinylpolypyrrolidone, lysozyme and skim milk powder.

A number of other agents are utilized to adjust the taste of wine. Gum Arabic for example reduces astringency and the bitterness caused by low molecular weight tannins. Grape tannins may be added to improve the flavor and introduce varietal taste and copper sulfate removes impurities such as hydrogen sulfide and improves the taste and aroma of wine.

Filtration prior to bottling clarifies and stabilizes the wine by capturing large particles that affect the visual appearance of the wine as well as organisms that can cause re-fermentation or spoilage. After filtering a final dose of sulfite added as a preservative and to prevent unwanted fermentation in the bottle. The wine bottles are then sealed with a cork or alternatively a synthetic cork or screw cap, which is less subject to cork tainting that, can damage wine.

A number of problems can arise from the fermentation process or storage that affect the flavor of the wine. For example, a wine made from young grapes can have excessive acidity, bitterness and a vegetative taste; a wine made from grapes grown in a hot climate can have high acid and tannin content; high pressure pressing of the grape skins during the fermentation step can result in high tannin content; a wine left on the “lees” for an extended period of time can generate hydrogen sulfide and/or mercaptans that give the wine a rotten egg odor; residual bacterial activity from fermentation can result in the generation of unwanted acetic acid and enhanced oxidation resulting in poor taste and a poorly sealed cork can result in oxidation of the wine; and trichloroanisole from a defective cork can both result in a musty flavored wine.

The flavor of wine can also be affected if not completely consumed after opening. The environment in an unopened bottle of wine is chemically reductive since the wine making process attempts to remove most of the oxygen in the wine prior to bottling. However, once the bottle is opened, oxygen from decanting or the use of a venturi begins the oxidative process. Within an hour or two after opening, oxygen in the air begins to deteriorate the wine. The phenols and tannins are oxidized and hydrogen peroxide created from other side reactions lowers the concentration of sulfites, which enhances subsequent oxidation. Hydrogen peroxide also oxidizes alcohol producing an aldehyde that gives wine a stale taste and a slight bitterness. In white wines, oxidation causes the formation of quinones from tannins changing the wine to a slightly brown color also commonly referred to as “browning”.

Tannins are polyphenolic compounds that bind to and precipitate proteins. Polyphenols are a group of compounds that are vitally important in wine. In red wines, an excess of higher molecular tannins results in astringency while lower molecular weight tannins increase the bitterness of wine. Historically, increased concentrations of tannins were preferred because they reacted with oxygen in the bottle and gave longer life to the wine. Today wines are consumed before they have aged significantly and higher tannin concentrations are associated with lower quality wines. To address this problem wine is removed from the “lees” sooner decreasing contact with the skins and by adding an agent to reduce the tannins after fermenting. Gelatin is a common agent used to decrease high molecular weight tannins in wine. The lower molecular weight tannins are commonly reduced with gum Arabic and PVPP.

Another method to reduce the bitterness of tannins is to oxidize the tannins just prior to drinking. Venturi and carafe oxidation are methods used to increase the oxygen in wine and thereby the oxidation of tannins. However, these devices do not oxygenate in a controlled manner.

Reducing oxygenation during the storage and bottling process has been a major effort for the wineries. Oxygen enters the storage vessels each time they are opened for sampling, pumping, blending, or addition of agents. Consequently, a variety of systems and methods have been utilized to reduce oxygen including air rejecting pumps, use of nitrogen or argon to blanket the wine during processing and performing the bottling process under a vacuum.

Agents such as sulfites, ascorbic acid and gum Arabic may be added during preparation that improves the taste and aroma of wines. Copper sulfate may be added to wine to reduce hydrogen sulfide concentration and ascorbic acid is sometimes added to remove oxygen from the wine before bottling.

Wines will continue to be produced with high concentrations of tannins and increased acidity to provide oxidation resistance and other problems resulting from age. Consequently, there is a need in the industry for a composition that can be added to wine, whether in large or small volume that effectively tempers the bitterness, reduces the astringency, corrects for high acidity, increases the aroma, and improves taste.

### BRIEF SUMMARY OF THE INVENTION

The present invention provides compositions and methods of using these compositions to improve the taste, aroma and quality of wine. In one aspect, an aqueous solution is provided comprising ascorbic acid having a concentration of about 223 g/L to about 273 g/L and gum Arabic having a concentration of about 46 g/L to about 56 g/L. When added to a glass of white wine, or in larger volumes to a bottle or cask of wine, it improves the taste by reducing the bitterness and apparent acidity.

In a second aspect, an aqueous solution is provided comprising gelatin having a concentration of about 45 g/L to about 55 g/L, gum Arabic having a concentration of about 92 g/L to about 112 g/L and copper sulfate having a concentration of about 0.014 g/L to about 0.018 g/L. When added dropwise to a glass of red wine, or in larger volumes to a bottle or cask of wine, it improves the taste by reducing the astringency, bitterness and apparent acidity.

In a third aspect, an aqueous solution is provided comprising gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L. When added to a glass of wine, or in larger volumes to a bottle or cask of wine, it improves the taste by reducing the bitterness and apparent acidity.

In one embodiment of these aspects, the gelatin is Inocolle gelatin and the gum Arabic is Aromagum gum Arabic.

In a fourth aspect of the present invention a method is provided for improving the taste, aroma and quality of wine comprising the steps of adding a volume of an aqueous solution containing:

gelatin having a concentration of about 45 g/L to about 55 g/L, gum Arabic having a concentration of about 92 g/L to about 112 g/L and copper sulfate having a concentration of about 0.014 g/L to about 0.018 g/L, or

ascorbic acid having a concentration of about 223 g/L to about 273 g/L and gum Arabic having a concentration of about 46 g/L to about 56 g/L or

gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L to a glass, a bottle or cask of wine; and mixing said wine.

In a fifth aspect, a kit for improving the taste of wine is provided comprising:

a first dispensing bottle containing an aqueous solution of gelatin having a concentration of about 45 g/L to about 55 g/L, gum Arabic having a concentration of about 92 g/L to about 112 g/L and copper sulfate having a concentration of about 0.014 g/L to about 0.018 g/L;

a second dispensing bottle containing an aqueous solution of ascorbic acid having a concentration of about 223 g/L to about 273 g/L and gum Arabic having a concentration of about 46 g/L to about 56 g/L,

a third dispensing bottle containing an aqueous solution of gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L; and an instruction manual.

Other aspects of the invention are found throughout the specification.

### BRIEF DESCRIPTION OF THE DRAWINGS

None

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “astringency” as used herein refers to the drying, roughing and sometimes puckering sensation or feeling that is experienced after tasting most red wines. Astringency is an in-mouth experience that is a touch sensation and not a taste. The polymeric flavan-3-ols, also known as tannins, are primarily responsible for the astringency of wines.

The term “tannin” or “tannins” as used herein refers to an astringent, bitter plant polyphenolic compound that binds to and precipitates proteins and various other organic compounds including amino acids and alkaloids. Tannins have molecular weights ranging from 500 to over 3,000 as gallic acid esters and up to 20,000 as proanthocyanidins. They are incompatible with gelatin, metallic salts and strong oxidizing agents and form complexes that precipitate in aqueous solution.

The term “high acidity” as used herein refers to a low pH. The acid or base content of an aqueous solution can be measured by pH, which is a logarithm of the reciprocal of hydrogen-ion concentration in gram atoms per liter. The pH scale ranges in magnitude from 0 to 14 with a measurement of 7 indicating a neutral pH while a number greater than 7 is more basic and less than 7 is more acidic.

The term “isinglass” as used herein refers to a collagen, similar to gelatin obtained from the dried swim bladders of fish, used mainly for the clarification of wine.

The present invention provides compositions and methods of using these compositions to improve the taste, aroma and quality of wine. One composition is an aqueous solution comprising ascorbic acid having a concentration of about 223 g/L to about 273 g/L and gum Arabic having a concentration of about 46 g/L to about 56 g/L. This composition improves the taste by reducing the bitterness when added to a glass of white wine, or in larger volumes to a bottle or cask of wine.

A second composition is an aqueous solution comprising gelatin having a concentration of about 45 g/L to about 55 g/L, gum Arabic having a concentration of about 92 g/L to about 112 g/L and copper sulfate having a concentration of about 0.014 g/L to about 0.018 g/L. This composition improves the taste by reducing the astringency, bitterness and acidity when added dropwise to a glass of red wine, or in larger volumes to a bottle or cask of wine.

A third composition is an aqueous solution comprising gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L. This composition improves the taste by reducing the bitterness and acidity when added to a glass of wine, or in larger volumes to a bottle or cask of wine.

### 1. Gum Arabic

Gum Arabic also known as acacia gum, chaar gund, char goond, or meska, is a natural gum made of hardened sap taken from two species of the acacia tree; Acacia senegal and Acacia seyal. The gum is harvested commercially from wild trees throughout the Sahel from Senegal and Sudan to Somalia, although it has been historically cultivated in Arabia and West Asia. Gum Arabic's mixture of polysaccharides and glycoproteins gives it the properties of a glue and binder. It has been extensively tested and is one of the safest food additives for human consumption. In the US, gum Arabic is distributed by wine products companies for the fining or improvement of wine during production.

Gum Arabic acts as a protective colloid, binding with tannins and forming a coagulated structure that remains in suspension. Its polysaccharide component re-balances the wine in the mouth reducing the perception of dryness, astringency, bitterness and acidity. Aromagum is a preferred gum Arabic. The objective in the production of Aromagum is to modify the structure and size of the gum in such a manner as to obtain a molecule, which is capable of preferentially binding with the high molecular weight esters. This makes the unpleasant compounds non-volatile so the harsher vegetal, oxidized, pungent and animal-like aromas are bound and out of the sensory pathway and the remaining fresh, fruity, flowery notes of the wine more prominent. The benefit of the addition of Aromagum to wine has been observed to be effective for over a year.

Aromagum will form heavy precipitates when the pH of the mixture is increased. Consequently, Aromagum is used at about pH of 3.7 or less to stabilize the mixture against precipitation. The concentration of Aromagum will vary depending on the type of wine and may range from about 40 g/L to about 160 g/L. For red wines or wines with a high tannin content, the concentration may range from about 85 g/L to about 150 g/L, preferably 92 g/L to about 112 g/L. Most preferably the concentration is about 102 g/L. For white wines the concentration may range from about 40 g/L to about 60 g/L, preferably 46 g/L to about 56 g/L. Most preferably the concentration is about 51 g/L.

Other gum Arabics were tested but did not have the desired characteristics of Aromagum. LGA 20 and LGA 30 gum Arabics formed a crystalline precipitate with gelatin arabinol, inogum, maxigum and citrogum formed precipitates at the desired pH. Gelogum provided good formulations but did not improve the aroma or taste of the wine.

### 2. Gelatin

A number of proteineous fining agents are currently used in the wine industry to reduce polymerized phenols or tannins in red wine. Some of these include egg albumin, casein, potassium caseinate and isinglass. However, each of these agents has disadvantages. Casein and potassium caseinate have a shelf life of less than one year. Isinglass produces a fishy smell as it ages and is not as effective as other animal gelatins in removing high molecular weight tannins. Egg albumin is does not have the desired shelf life and its ability to remove high and low molecular weight tannins is unpredictable. Animal gelatins such as cow and pig gelatin have many of the desired characteristics for removing tannins. Lower molecular weight gelatins are predictable for removing lower molecular weight tannins associated with bitterness and higher molecular weight gelatins are predictable for removal of higher molecular weight tannins associated with astringency. Commercially available gelatins vary widely in their molecular weight depending on whether the hydrolysis used in their manufacture is chemical (larger sizes) or enzymatic (smaller sizes). This predictability may be utilized for determining the choice of materials for a particular purpose.

Testing revealed different types of gelatin would effectively decrease astringency or bitterness of a wine. However, no single type of gelatin was able to reduce both astringency and bitterness. The present invention utilizes a combination of high molecular weight and low molecular weight gelatin to remove the differing molecular weight tannins present in wine. This combination has never been utilized in the winemaking industry nor was there a reason to consider such a formulation. The reason is that astringency is regulated by adding gelatin at a specific step in the wine making process. Correspondingly, bitterness is also regulated by addition of gum Arabic at another step in the wine making process. Consequently, there is no reason for a winery to combine the two.

During testing it was found that certain combinations of gelatins caused undesirable chemical reactions. Colle Perle gelatin was initially used due to the high molecular weight and astringency reduction. Unfortunately, this gelatin formed an undesirable precipitate with several gum Arabics. Liquagel-50 effectively removes tannins normally attributed to astringency, but also formed light precipitates with gum Arabic formulations. Other gelatins including Hydroclar 30, Hydroclar 45, Clargel, and Idrosol also had undesirable reactions with gum Arabics. However, Inocolle, which is a partially hydrolyzed gelatin solution, did not form precipitates with gum Arabics at the desired pH ranges and was found to improve the aroma and flavor of wine.

The concentration of gelatin may range from about 20 g/L to about 80 g/L. In the first and second compositions the gelatin may range from about 40 g/L to about 60 g/L, preferably about 45 g/L to about 56 g/L. In the third composition the gelatin may range from about 80 g/L to about 115 g/L, preferably 86 g/L to about 106 g/L.

### 3. Ascorbic Acid

Ascorbic acid or vitamin C has long been used in wine making as an anti-oxidant because of its ability to rapidly remove molecular oxygen from juice or wine. This reaction occurs much faster than the reaction between sulfur dioxide and oxygen. Sulfur dioxide is also utilized as an anti-oxidant as well as an antimicrobial agent to protect wine from spoilage by bacteria and oxidation. However, sulfur dioxide does not react directly with oxygen, but instead reacts with hydrogen peroxide, which is formed through the oxidation of phenolic compounds. Ascorbic acid occurs in grapes at low concentrations but is rapidly oxidized during racking and crushing of grapes. Consequently, ascorbic acids is often added to the must or wine before bottling. In the present invention ascorbic acid is utilized to reduce oxidation of the wine after being exposed to the air.

The concentration of ascorbic acid may range from about 5 g/L to about 300 g/L. In the second composition the ascorbic acid may range from about 215 g/L to about 300 g/L, preferably from about 223 g/L to about 273 g/L. In the third composition the ascorbic acid may range from about 5 g/L to about 30 g/L, preferably about 9.9 g/L to about 11.0 g/L.

### 4. Other Agents

Copper sulfate is a fining agent used to remove unpleasant hydrogen sulfide and other sulfide-like aromas in wine. Hydrogen sulfide is volatile natural product of fermentation and it can be present in wine as mono-mercaptans that produce what is generally described as a rotten-egg aroma. Copper immediately reacts with hydrogen sulfide and form copper sulfide when added to a wine. The copper sulfate concentration may range from about 0.0045% to about 0.0055% or from about 0.014 to about 0.018 g/L.

Potassium metabisulfite is a common must or wine additive. In wine it forms sulfur dioxide gas that both prevents microbial growth and acts as a potent antioxidant, protecting both the color and delicate flavors of wine. The potassium metabisulfite concentration may range from 1.5% to about 10.0% or from about 7 to about 47 g/L, preferably from about 12 to 15 g/L.

The first composition, comprising gum Arabic, gelatin and copper sulfate, is formulated to reduce high molecular weight tannins that result in astringency and low molecular weight tannins that result in bitterness in red wines. The combination of acidity and tannins affects the smoothness or suppleness of wine. When this composition is applied to wine it reduces the tannin content and allows the acidity to be tolerated sensorially because the sum of the two is lower. Consequently, this formulation may be used to smooth wines high in tannins that may also be high in acidity. Copper sulfate is added to this composition to enhance the aroma by reducing hydrogen sulfide that produces the rotten egg smell in a newly opened.

The second composition, comprising gum Arabic and ascorbic acid, is formulated to reduce bitterness resulting from oak storage and reduce oxidation of the wine after it is opened. The bitterness is removed or tempered by gum Arabic by the removal of low molecular weight tannins. In the event that the acidity is high, tannin removal will compensate for the high acidity by making the total of the tannins and the acidity lower improving the suppleness of the wine. Ascorbic acid is an oxygen scavenger and reverses the reaction of phenols with oxygen that creates quinones causing white wines to brown. Maximizing the box tree and passion fruit ‘notes’ in Sauvignon Blanc is very important for that varietal wine and requires control of oxidative degradation. Lowering the oxygen exposure helps to lower oxidative degradation. This is a primary reason why ascorbic acid is added to the juice before pressing the skins. Ascorbic acid can also limit the oxidation of important aroma producing compounds such as fruit esters and terpenes, thereby enhancing the aroma of wine.

The third composition, comprising gum Arabic, gelatin, ascorbic acid and potassium metabisulfite, is formulated to decrease astringency, removing bitterness and reduce oxidation in each of the ways disclosed above for the first and second compositions. The potassium metabisulfite forms sulfur dioxide gas that both prevents microbial growth and acts as a potent antioxidant, protecting both the color and delicate flavors of wine.

### 5. Use

In use, the wine is tasted and if adjustment is required a volume of the composition is mixed in to the wine. The wine is tasted again and if further adjustment is required additional volumes of the composition may be mixed into the wine until the desired taste is achieved. Thus the astringent characteristic of the wine is adjusted in steps to meet the critical taste requirement of the consumer. It was determined by taste testing that higher percentages of gelatin removed tannins too rapidly, which did not allow for incremental changes necessary for a discerning palate. Similarly, high percentages of Aromagum can be detected tactually even though it is not tasted which can result in an undesirable sense of touch in the mouth.

In some white wines storage in American or French oak wooden barrels can cause bitterness. The barrels impart the pleasant vanillin taste but oak tannins can impart the slight astringency and bitterness. In addition, the generally low tannin content of white wines makes them susceptible to oxidation, which causes a stale taste and reduced aroma. Another concern with white wines is that their acidity is frequently high. Wine makers have often used potassium carbonate to adjust the acidity of the white grape juice prior to fermentation. Consequently, a formulation comprising gelatin to decrease astringency, gum Arabic to reduce bitterness and potassium bicarbonate to increase pH should be optimal for improving the taste of white wine. However, while mixtures of these compounds were chemically stable in aqueous solution they did not develop sufficient improvement in the wine based on sensory analysis. Gall nut tannins, that do not impart astringency or bitterness, were tested for their ability to reduce oxidation and improve the suppleness of the wine. While gall tannins improved the wine sensorially; the underlying bitterness remained. The addition of gum Arabic to gall tannins produced undesirable reactions and discoloration of the formulation. The addition of ascorbic acid to the gall tannins and gum Arabic produced formulations that were stable in a variety of concentration combinations. However, sensory testing indicated that bitterness was not reduced to an acceptable level. Independent sensory testing demonstrated that both gum Arabic and ascorbic acid reduced bitterness and improved the aroma and taste of white wine. However, a high concentration gum Arabic introduced an undesirable tactile sensation. In addition, low concentrations of ascorbic acid were not as effective as higher concentrations in reducing bitterness. Consequently, the second composition comprises a formulation of ascorbic acid in high concentration and gum Arabic in low concentration.

A concern of most consumers is the change in the taste of wine that is not completely consumed after being opened. Oxygen introduced into the bottle after opening results in the oxidation of ethyl alcohol into acetaldehyde, which increases bitterness and decreases the aroma resulting in a stale taste. The general treatment for oxidation in wines is the addition of ascorbic acid. Unfortunately a side reaction of the oxygen removal is the creation of hydrogen peroxide. Potassium metabisulfite may be added to remove the hydrogen peroxide by oxidation of the sulfite to sulfate. Consequently, it was determined that a concentration of about 2% to about 3% of both ascorbic acid and potassium metabisulfite would be sufficient to prevent oxidation. This determination was based on a 25% saturation of oxygen resulting from the pouring of several glasses from a bottle. A formulation containing about 3% made from a saturated aqueous solution of ascorbic acid at standard temperature and pressure was calculated to remove the oxygen in the wine at 25% saturation. A formulation containing about 2.2% made from a saturated aqueous solution of potassium metabisulfite at standard temperature and pressure was calculated to remove the hydrogen peroxide produced from the removal of oxygen by ascorbic acid. Since an excess of potassium metabisulfite is beneficial and excess ascorbic acid can be detrimental formulation containing about 3% of both ascorbic acid and potassium metabisulfite is preferred. Consequently, both ascorbic acid and metabisulfite were added to a 3% v/v with gelatin and gum Arabic to provide the third and fourth composition that decreases astringency, reduces bitterness and protects a wine from oxidation. Introducing this composition into an open bottle of wine or wine that has been decanted for later consumption will improve the aroma and taste and prevent oxidation for an extended period of time. Experimentation has observed little deterioration of wine due to oxidation for up to a week.

### 6. Packaging

The compositions of the present invention may be utilized for single glasses of wine, carafes of wine to a cask of wine. The compositions of the present invention may be added to wine by a variety of methods known to those skilled in the art. For example, the composition may be added to small volumes of wine drop-wise or by spray. It may also be added in solid form that may include for example a tablet, a granulated crystal, a stir stick with the composition adhered to its surface or a tubular stir stick containing a liquid or solid composition within. For larger volumes of wine a syringe, pipette or other titrating equipment may be used to add the composition.

For ease of use and transport, compositions of the present invention have been prepared in flexible plastic dropper bottle. However, a variety of holding containers may be used. The flexible plastic dropper bottle provides a screw top that helps reduce contamination. During use the dropper tip is inverted over the wine the bottle is squeezed until a single drop is dispensed in the glass of wine. The concentration of each ingredient in the compositions of the present invention were determined to be an amount that would result in a detectable adjustment in the taste aroma and quality of the wine from a single dispensed drop. This would allow the consumer to make incremental adjustments to a glass of wine a single drop at a time until the desired taste was achieved.

A flexible plastic spray bottle, such as those used for nasal spray, may dispense a mist onto the surface of wine. The flexible plastic spray bottle also provides a screw cap that helps reduce contamination. During use it is inverted over the glass or bottle and squeezed dispensing a specific amount of material, often referred to as a titration. This can be used for a partially filled bottle of wine that may not be consumed for several days.

A pour through cylinder may be used for decanting wine into a separate holding container such as a carafe or for pouring into glasses of wine. The venturi effect for introducing air into the wine may be accomplished by providing holes in the pour through cylinder. The pour through cylinder may be made form a variety of materials including glass and polymer plastic. It is filled with polyethylene wrapping material comprising a large surface area. Attached to the polypropylene wrapping material is a formulation of gelatin, gum Arabic, ascorbic acid, and potassium metabisulfite, either dissolved in water or in powder form. These ingredients will dissolve in the wine as it is pored through the cylinder reducing tannins, bitterness and dissolved oxygen thereby improving aroma and taste.

The information set forth above is provided to give those of ordinary skill in the art a complete disclosure and description of how to make and use the embodiments of the device and methods, and are not intended to limit the scope of what the inventor regards as his invention. Modifications of the above-described modes for carrying out the invention that are obvious to persons of skill in the art are intended to be within the scope of the following claims. All publications, patents, and patent applications cited in this specification are incorporated herein by reference.

What is claimed is:

1. A composition comprising an aqueous solution of gelatin having a concentration of about 45 g/L to about 55 g/L, gum Arabic having a concentration of about 92 g/L to about 112 g/L and copper sulfate having a concentration of about 0.014 g/L to about 0.018 g/L.

2. The composition according to claim 1, wherein said gelatin is Inocolle gelatin.

3. The composition according to claim 2, wherein said concentration of Inocolle gelatin is about 50 g/L.

4. The composition according to claim 1, wherein said gum Arabic is Aromagum gum Arabic.

5. The composition according to claim 4, wherein the concentration of Aromagum gum Arabic is about 102 g/L.

6. The composition according to claim 1, wherein the concentration of copper sulfate is about 0.016 g/L.

7. A composition comprising an aqueous solution of ascorbic acid having a concentration of about 223 g/L to about 273 g/L and gum Arabic having a concentration of about 46 g/L to about 56 g/L.

8. The composition according to claim 7, wherein the gum Arabic is Aromagum gum Arabic.

9. The composition according to claim 8, wherein the concentration of Aromagum gum Arabic is about 51 g/L.

10. The composition according to claim 7, wherein the concentration of ascorbic acid is about 248 g/L.

11. A composition comprising an aqueous solution of gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L.

12. The composition according to claim 11, wherein the gelatin is Inocolle gelatin.

13. The composition according to claim 12, wherein said concentration of Inocolle gelatin is about 47 g/L.

14. The composition according to claim 11, wherein the gum Arabic is Aromagum gum Arabic.

15. The composition according to claim 14, wherein the concentration of Aromagum gum Arabic is about 96 g/L.

16. A method for reducing the astringency and bitterness of a wine comprising the steps of:
providing a volume of a composition comprising an aqueous solution of gelatin having a concentration of about 45 g/L to about 55 g/L, gum Arabic having a concentration of about 92 g/L to about 112 g/L and copper sulfate having a concentration of about 0.014 g/L to about 0.018 g/L to a glass of wine and
mixing said glass of wine.

17. The method according to claim 16, wherein said wine is a red wine.

18. A method for reducing the bitterness of a wine comprising the steps of:
providing a volume of a composition comprising an aqueous solution of ascorbic acid having a concentration of about 223 g/L to about 273 g/L and gum Arabic having a concentration of about 46 g/L to about 56 g/L to a glass of wine and
mixing said glass of wine.

19. The method according to claim 18, wherein said wine is a white wine.

20. A method for reducing the oxidation of wine after the bottle of wine has been opened comprising the steps of: providing a volume of a composition comprising an aqueous solution of gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L to said opened bottle of wine.

21. A kit for improving the taste of wine comprising:
a first dispensing bottle containing an aqueous solution comprising gelatin having a concentration of about 45 g/L to about 55 g/L, gum Arabic having a concentration of about 92 g/L to about 112 g/L and copper sulfate having a concentration of about 0.014 g/L to about 0.018 g/L;
a second dispensing bottle containing an aqueous solution comprising an aqueous solution of ascorbic acid having a concentration of about 223 g/L to about 273 g/L and gum Arabic having a concentration of about 46 g/L to about 56 g/L;
a third dispensing bottle containing an aqueous solution comprising an aqueous solution of gelatin having a concentration of about 42 g/L to about 52 g/L, gum Arabic having a concentration of about 86 g/L to about 106 g/L, ascorbic acid having a concentration of about 9.9 g/L to about 11 g/L and potassium metabisulfite having a concentration of about 12 g/L to about 15 g/L; and
an instruction manual.
